(19) United States
(12) Patent Application Publication
(10) Pub. No.: US 2024/0302539 A1
(43) Pub. Date: Sep. 12, 2024

(54) POSITIONING METHOD, POSITIONING APPARATUS, AND SATELLITE SYSTEM

(71) Applicants: Koya Takata, Tokyo (JP); Kenji WAKAFUJI, Tokyo (JP); Masahiro KAIDEN, Tokyo (JP)

(72) Inventors: Koya Takata, Tokyo (JP); Kenji WAKAFUJI, Tokyo (JP); Masahiro KAIDEN, Tokyo (JP)

(21) Appl. No.: 18/278,585

(22) PCT Filed: Jan. 14, 2022
(86) PCT No.: PCT/JP2022/001200

§ 371 Date: Aug. 23, 2023

(51) Int. Cl. G01S 19/43; G01S 19/04

(52) U.S. Cl. CPC G01S 19/43; G01S 19/04

(57) ABSTRACT

A positioning method of the present disclosure includes: generating first observation data through observation of phases of a plurality of carrier waves transmitted from a plurality of transmitting stations in a first satellite; generating second observation data through observation of the phases of the plurality of the carrier waves in a second satellite; performing phase difference calculation to calculate a phase difference of the plurality of the carrier waves observed in the first satellite and the second satellite using the first observation data and the second observation data; performing base line vector calculation to calculate a base line vector indicating relative positions of the first satellite and the second satellite based on the phase difference calculated by performing the phase difference calculation; and performing the phase difference calculation and the base line vector calculation by either one of the second satellite or a positioning apparatus located on the ground.

### TECHNICAL FIELD

The present disclosure relates to a positioning method, a positioning apparatus, and a satellite system, in particular to a positioning method, a positioning apparatus, and a satellite system each configured to determine the relative positions of satellites.

### BACKGROUND ART

As a satellite communication system in which communication is performed using satellites, there are given satellite constellation systems in which a communication network is built by making a plurality of satellites work cooperatively. Among these satellite constellations, one which uses low earth orbit satellites is called a LEO (Low Earth Orbit) constellation. In recent years, applied technology related to LEO satellites for building satellite constellations has been developed. For example, Patent Literature 1 discloses one example of a positioning technique for determining the relative positions of satellites.

Patent Literature 1 discloses a technique in which each satellite has a high-performance time synchronization mechanism and a transmission-reception mechanism mounted thereon, the transmission-reception mechanism for sending and receiving time information to and from satellites, and by exchanging the time information between the satellites, the positioning of the satellites with respect to one another can be determined with high accuracy.

### CITATION LIST

### Patent Literature

Patent Literature 1: International Patent Publication No. WO 2013/036328

### SUMMARY OF INVENTION

### Technical Problem

However, the technique disclosed in Patent Literature 1 has a problem that a highly accurate time synchronization mechanism and a transmission-reception mechanism for sending and receiving time information are large and heavy, and thus being a cause of an increase in the weight of a satellite.

### Solution to Problem

According to an aspect of the present disclosure, a positioning method includes: generating first observation data through observation of phases of a plurality of carrier waves transmitted from a plurality of transmitting stations in a first satellite; generating second observation data through observation of the phases of the plurality of the carrier waves in a second satellite; performing phase difference calculation to calculate a phase difference of the plurality of the carrier waves observed in the first satellite and the second satellite using the first observation data and the second observation data, respectively; performing base line vector calculation to calculate a base line vector indicating relative positions of the first satellite and the second satellite based on the phase difference calculated by performing the phase difference calculation; and performing the phase difference calculation and the base line vector calculation by either one of the second satellite or a positioning apparatus located on the ground.

According to an aspect of the present disclosure, a positioning apparatus includes: phase difference calculation means for performing phase difference calculation of a plurality of carrier waves observed in a first satellite and a second satellite using first observation data and second observation data, respectively, the first observation data being obtained through observation of phases of a plurality of carrier waves transmitted from a plurality of transmitting stations in the first satellite and the second observation data being obtained through observation of the phases of the plurality of the carrier waves in the second satellite; and base line vector calculation means for calculating a base line vector indicating relative positions of the first satellite and the second satellite based on the phase difference calculated by performing the phase difference calculation means, wherein the phase difference calculation means and the base line vector calculation means are installed in either one of the second satellite or the positioning apparatus located on the ground.

According to an aspect of the present disclosure, a satellite system includes: a first satellite; a second satellite; at least four transmitting stations set up on the ground and configured to transmit carrier waves to the first satellite and the second satellite; and a receiving station set up on the ground and configured to receive data transmitted from the first satellite and the second satellite, wherein first observation data is generated through observation of the phases of the plurality of the carrier waves in the first satellite, the plurality of carrier waves being transmitted from the plurality of the transmitting stations, second observation data is generated through observation of the phases of the plurality of the carrier waves in the second satellite, phase difference calculation is performed to calculate a phase difference of the plurality of the carrier waves observed in the first satellite and the second satellite using the first observation data and the second observation data, respectively, base line vector calculation is performed to calculate a base line vector indicating relative positions of the first satellite and the second satellite based on the phase difference calculated by performing the phase difference calculation, and the phase difference calculation and the base line vector calculation are performed by either one of the second satellite or the receiving station located on the ground.

### Advantageous Effects of Invention

According to a positioning method, a positioning apparatus, and a satellite system according to the example embodiments, satellites can be reduced in size and weight.

### BRIEF DESCRIPTION OF DRAWINGS

FIG. 1 is a schematic view of a satellite system according to a first example embodiment;

FIG. 2 is a diagram illustrating carrier waves used for performing positioning in a positioning satellite system according to the first example embodiment;

FIG. 3 is a block diagram of a positioning apparatus according to the first example embodiment;

FIG. 4 is a flowchart illustrating a flow of a positioning method according to the first example embodiment;

FIG. 5 is a schematic diagram of a satellite system according to a second example embodiment;

FIG. 6 is a block diagram of a positioning apparatus according to the second example embodiment; and

FIG. 7 is a flowchart illustrating a flow of a positioning method according to the second example embodiment.

### EXAMPLE EMBODIMENT

### First Example Embodiment

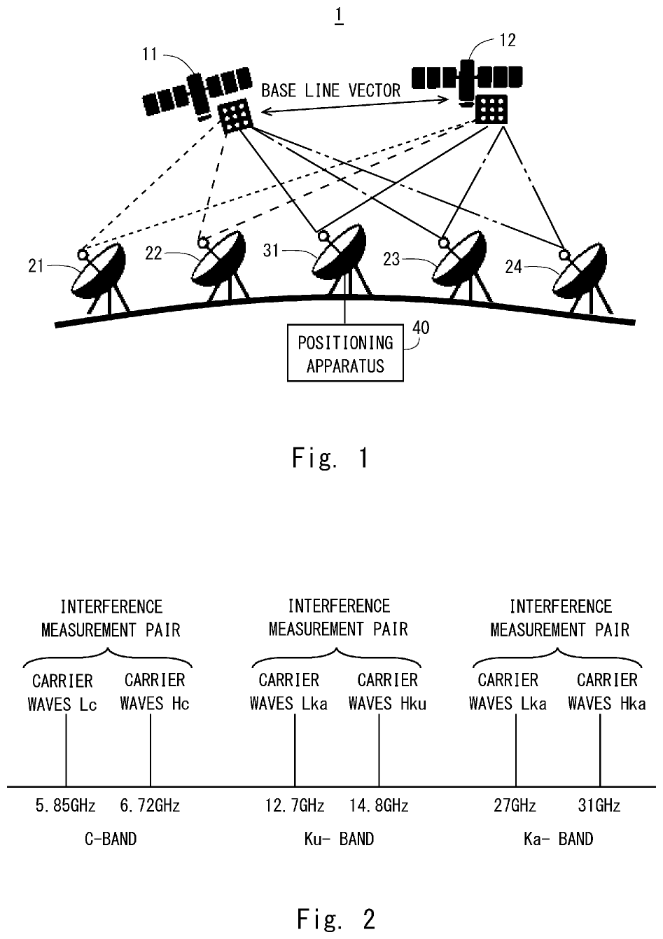

An example embodiment of the present disclosure will be described below with reference to the drawings. FIG. 1 shows a schematic view of a satellite system 1 according to a first example embodiment. The satellite system 1 according to the first example embodiment performs communication via satellites with a ground station located on the ground. As shown in FIG. 1, the satellite system 1 according to the first example embodiment includes satellites 11 and 12, transmitting stations 21 to 24, a receiving station 31, and a positioning apparatus 40. The numbers of the satellites, the transmitting stations, and the receiving stations shown in FIG. 1 are only one example, and a larger number of the satellites, the transmitting stations, and the receiving stations may be incorporated in a satellite system.

In the satellite system 1, data is transmitted from the transmitting stations 21 to 24 to the satellite 11 and the satellite 12 via carrier waves. The satellites 11 and 12 perform posture control based on the data transmitted via carrier waves and perform communication with the receiving station 31 set up on the ground. Then, in the satellite system 1, the phases of the carrier waves transmitted from the transmitting stations 21 to 24 is counted by the satellite 11 and the satellite 12 to generate observation data, and positioning is performed to measure the relative positions of the satellites 11 and 12 using the observation data. In the satellite system 1 according to the first example embodiment, the positioning apparatus 40 for performing positioning calculation is installed in the receiving station 31 or in a system to which the receiving station 31 is connected. In the satellite system 1 according to the first example embodiment, when positioning is performed to determine the relative positions of the satellites, an interference positioning system in which positioning is performed based on the phases of the carrier waves is used.

Here, the carrier waves through which the satellites 11 and 12 count the phases will be described. FIG. 2 shows a diagram for explaining the carrier waves used for performing positioning in the satellite system 1 according to the first example embodiment. In the satellite system 1, the available frequency bands for the carrier waves vary depending on the satellites, so the frequency bands for the carrier waves that are to be transmitted to the satellites are switched to match the respective satellites to which the carrier waves are to be transmitted. In the example shown in FIG. 2, three frequency bands are used, namely C-band that uses the frequency band centered at 6.285 GHZ, Ku-band that uses the frequency band centered at 13.75 GHZ, and Ka-band that uses the frequency band centered at 29 GHz.

Then, in the satellite system 1, two carrier waves with frequencies defined in the C-band, the Ku-band and the Ka-band are used in performing positioning. Positioning can be performed by transmitting carrier waves of a single frequency from a plurality of transmitting stations. Alternatively, positioning can be performed by transmitting carrier waves of different frequencies belonging to a single frequency band from a plurality of transmitting stations. When carrier waves of two frequencies are used for performing positioning, it is preferable to use the carrier waves of the lowest frequency and the carrier waves of the highest frequency in each frequency band. As described above, by increasing the frequencies of the carrier waves used or combining the carrier waves of frequencies that are as far apart as possible from each other, the accuracy of the phase difference calculation performed in the positioning apparatus 40 and the speed of the calculation can be improved.

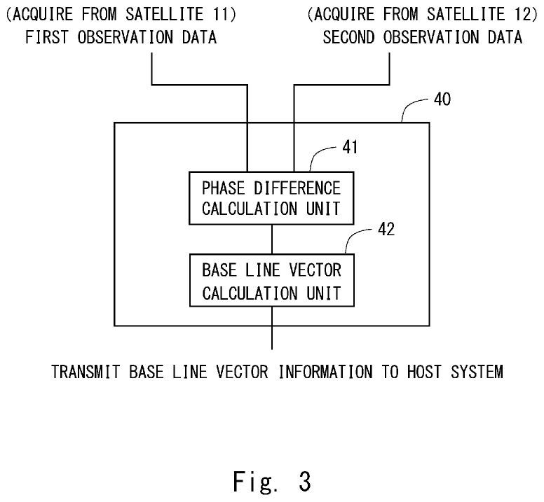

Next, the positioning apparatus 40, which calculates a base line vector indicating the relative positions of the satellites in the satellite system 1, will be described in detail below. FIG. 3 shows a block diagram of the positioning apparatus 40 according to the first example embodiment. As shown in FIG. 3, the positioning apparatus 40 includes a phase difference calculation unit 41 and a base line vector calculation unit 42. The positioning apparatus 40 receives first observation data and second observation data from the first satellite and the second satellite, respectively, the first observation data containing the count value of the carrier waves observed by the first satellite (for example, the satellite 11) and the second observation data containing the count value of the carrier waves observed by the second satellite (for example, the satellite 12).

The phase difference calculation unit 41 then performs the phase difference calculation of the plurality of the carrier waves observed in the satellite 11 and the satellite 12 using the first observation data, which is observation data of the phases of the plurality of the carrier waves having different frequencies obtained in the satellite 11, and the second observation data, which is observation data of the phases of the plurality of the carrier waves obtained in the satellite 12. Note that the phase difference calculation unit 41 performs calculation of the double phase difference, which is calculation of the phase difference of two carrier waves observed at two observation points (for example, the satellites 11 and 12).

The base line vector calculation unit 42 performs base line vector calculation, which is calculation of the base line vector indicating the relative positions of the satellite 11 and the satellite 12 based on the phase difference calculated by the phase difference calculation unit 41. The base line vector calculation unit 42 then transmits the value of the calculated base line vector to a host system. In the satellite system 1, the base line vector calculated by the base line vector calculation unit 42 is used to perform communication control using the satellites 11 and 12, posture control of the satellites 11 and 12, and the like.

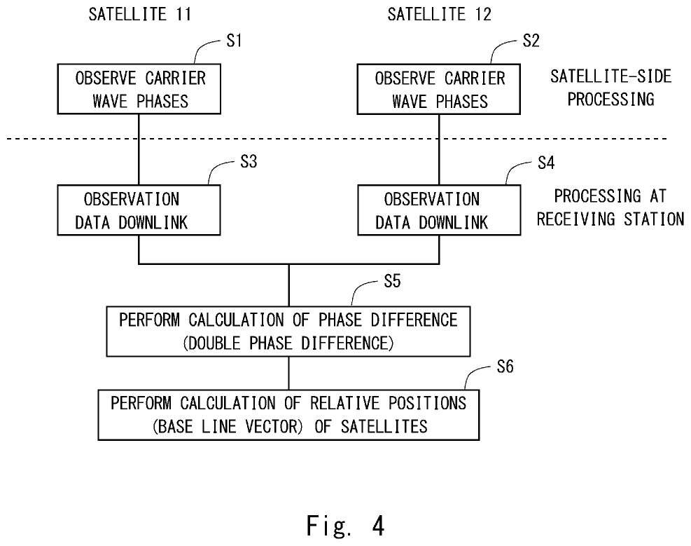

Next, a positioning method performed by the satellite system 1 according to the first example embodiment will be described. FIG. 4 shows a flow chart illustrating a flow of the positioning method according to the first example embodiment. As shown in FIG. 4, in the positioning method of the satellite system 1 according to the first example embodiment, first, the phases of the carrier waves sent out from the transmitting stations 21 to 24 is observed by the satellites 11 and 12, and then the satellite 11 generates first observation data (Step S1) and the satellite 12 generates second observation data (Step S2).

Then, in the positioning method of the satellite system 1, the satellite 11 transmits the first observation data to the positioning apparatus 40 via the receiving station 31 (Step S3) and the satellite 12 transmits the second observation data to the positioning apparatus 40 via the receiving station 31 (Step S4). Then, in the satellite system 1, the phase difference calculation unit 41 performs calculation of the phase difference of the plurality of carrier waves observed in the satellite 11 and the satellite 12 using the first observation data and the second observation data (Step S5). Then, the base line vector calculation unit 42 performs base line vector calculation of the base line vector indicating the relative positions of the satellite 11 and the satellite 12 based on the phase difference calculated by the phase difference calculation unit 41 (Step S6). Here, in the satellite system 1, generation of observation data is performed in the satellites 11 and 12, and processing using the observation data is performed in the positioning apparatus 40 set up on the ground.

According to the above explanation, in the satellite system 1 according to the first example embodiment, observation of the phases of carrier waves and generation of the observation data showing the observation results are performed in the satellites 11 and 12, and calculation of the base line vector using the observation data is performed in the positioning apparatus 40 located on the ground. In addition, in the satellite system 1, transmission of the observation data by the satellites 11 and 12 to the positioning apparatus 40 is performed using the data transmission function that the satellites 11 and 12 have as a normal function for transmitting data to the receiving station 31. As a result, in the satellite system 1 according to the first example embodiment, the satellites 11 and 12 need only to have a function for observing the phases of the carrier waves, and there is no need to mount, on the satellites 11 and 12, any equipment for implementing the function for carrying out communication between the satellites and the function for carrying out the base line vector calculation, such equipment being a factor of increase in weight and volume of the satellites. Thus, in the satellite system 1 according to the first example embodiment, weight and volume of the satellites can be reduced.

In particular, in the LEO constellation in which satellites are in low orbit, the time taken for the satellites to deorbit due to gravity is short, and reduction in weight and size of the satellites will be especially crucial factors in extending the time to keep the satellites in orbit.

### Second Example Embodiment

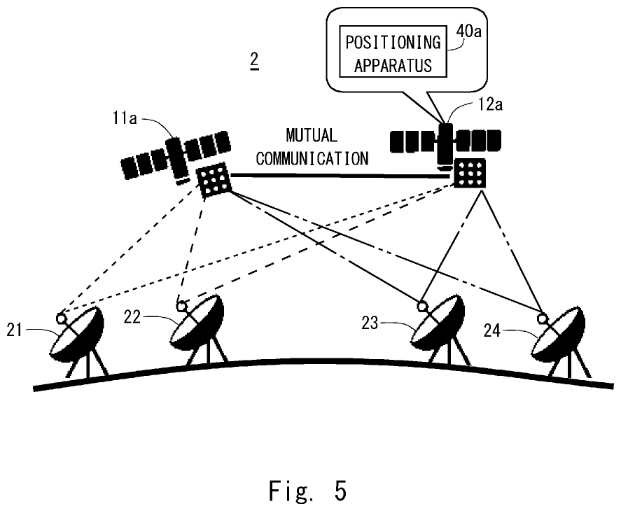

In a second example embodiment, an example in which a positioning apparatus is mounted on one of a plurality of satellites will be described. FIG. 5 shows a schematic diagram of a satellite system 2 according to the second example embodiment. The same components/elements as those of the first example embodiment are denoted by the same symbols as those used in the first example embodiment, and descriptions are omitted.

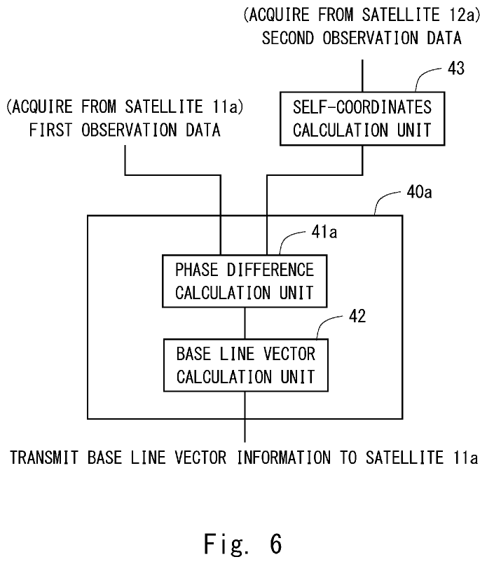

As shown in FIG. 5, in the satellite system 2 according to the second example embodiment, the receiving station 31 is not used for performing base line vector calculation. That is, in the satellite system 2, only the transmitting stations 21 to 24 are used to complete the base line vector calculation. The satellite system 2 according to the second example embodiment includes satellites 11a and 12a instead of the satellites 11 and 12. The satellite 11a has a communication function for performing communication with the satellite 12a in addition to the function of the satellite 11. The satellite 12a has, in addition to the function of the satellite 12, a communication function for performing communication with the satellite 11a and has a positioning apparatus 40a mounted thereon. The positioning apparatus 40a has virtually the same function as that of the positioning apparatus 40, but the values used in performing computation slightly differs. FIG. 6 shows a block diagram of the positioning apparatus 40a according to the second example embodiment.

As shown in FIG. 6, the positioning apparatus 40a has a phase difference calculation unit 41a instead of the phase difference calculation unit 41. The satellite 12a has a highly accurate time source, which is used by a self-coordinates calculation unit 43 to calculate the coordinates indicating the self-position of the satellite 12a calculated using the second observation data. Therefore, the phase difference calculation unit 41a performs calculation of the phase difference information including the phases of four carrier waves acquired by two satellites using the self-coordinates information calculated by the self-coordinates calculation unit 43 and the first observation data acquired from the satellite 11a. Then, the base line vector calculation unit 42 calculates the base line vector indicating the relative positions of the satellite 11 and the satellite 12 based on the phase difference calculated by the phase difference calculation unit 41 and transmits the calculated base line vector to the satellite 11a.

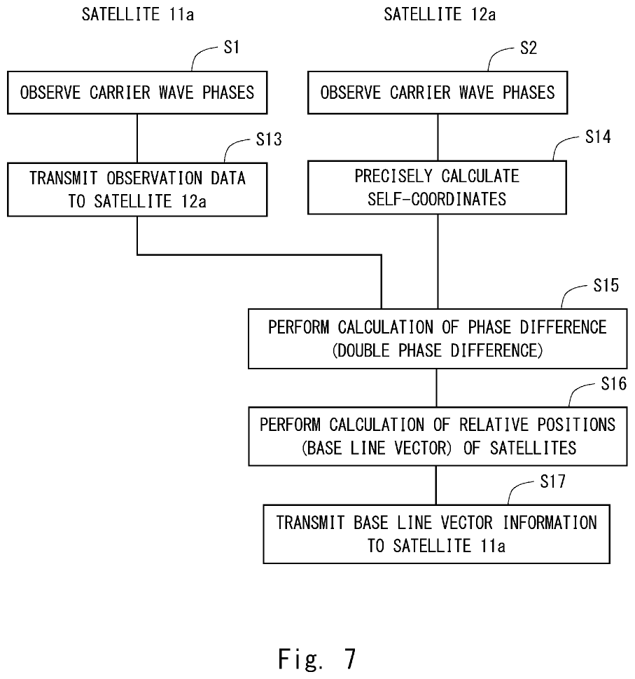

Next, an operation of the satellite system 2 according to the second example embodiment will be described. FIG. 7 shows a flow chart illustrating a flow of a positioning method according to the second example embodiment. As shown in FIG. 7, in the positioning method of the satellite system 2 according to the second example embodiment, first, the phase of the carrier waves sent out from the transmitting stations 21 to 24 is observed by the satellites 11a and 12a, then the satellite 11a generates first observation data (Step S1) and the satellite 12a generates second observation data (Step S2).

Then, in the positioning method of the satellite system 2, the satellite 11a transmits the first observation data to the positioning apparatus 40a of the satellite 12a (Step S13), and the satellite 12a calculates the precise self-coordinates by the self-coordinates calculation unit 43 using the second observation data (Step S14). Then, in the satellite system 2, the phase difference calculation unit 41a performs calculation of the phase difference of a plurality of carrier waves observed at the satellite 11a and the satellite 12a using the first observation data and the self-coordinates information calculated in Step S14 (Step S15). Then, the base line vector calculation unit 42 performs base line vector calculation to calculate the base line vector indicating the relative positions of the satellite 11a and the satellite 12a based on the phase difference calculated by the phase difference calculation unit 41a (Step S16). Here, in the satellite system 2, calculation of the base line vector is performed in the satellite 12a, and the calculated base line vector is transmitted to the satellite 11a (Step S17).

In the satellite system 2 according to the second example embodiment, it is not possible to reduce the volume and the weight of the satellite 12a, but it has an advantage in that it can use the existing facilities that are currently being launched. In addition, since the satellite system 2 according to the second example embodiment does not need to perform communication with the receiving station located on the ground, the computation delay caused due to the time required for performing computation can be reduced. Furthermore, like in the first example embodiment, in the satellite system 2 according to the second example embodiment, the weight and the volume of the satellite 11a can be reduced.

The present disclosure has been described above with reference to the example embodiments, but the present disclosure is not limited by the above description. Various modifications can be made to the configuration and details of the present disclosure that can be understood by those skilled in the art within the scope of the disclosure.

This application claims priority based on Japanese Application Special Application 2021-56410 filed on Mar. 30, 2021 the disclosure of which is herein incorporated by reference in its entirety.

### REFERENCE SIGNS LIST

1, 2 SATELLITE SYSTEM
11, 11a, 12, 12a SATELLITE
21-24 TRANSMITTING STATION
31 RECEIVING STATION
40, 40a POSITIONING APPARATUS
41, 41a PHASE DIFFERENCE CALCULATION UNIT
42 BASE LINE VECTOR CALCULATION UNIT
43 SELF-COORDINATES CALCULATION UNIT

What is claimed is:

1. A positioning method comprising:
generating first observation data through observation of phases of a plurality of carrier waves transmitted from a plurality of transmitting stations in a first satellite;
generating second observation data through observation of the phases of the plurality of the carrier waves in a second satellite;
performing phase difference calculation to calculate a phase difference of the plurality of the carrier waves observed in the first satellite and the second satellite using the first observation data and the second observation data, respectively;
performing base line vector calculation to calculate a base line vector indicating relative positions of the first satellite and the second satellite based on the phase difference calculated by performing the phase difference calculation; and
performing the phase difference calculation and the base line vector calculation by either one of the second satellite or a positioning apparatus located on the ground.

2. The positioning method according to claim 1, wherein the carrier waves include carrier waves of different frequencies.

3. The positioning method according to claim 1, wherein the plurality of the carrier waves are sent out from four or more ground stations installed at different locations.

4. The positioning method according to claim 1, wherein the phase difference calculation and the base line vector calculation are performed by a ground station system configured to receive the first observation data and the second observation data.

5. The positioning method according to claim 1, wherein
the phase difference calculation and the base line vector calculation are performed by the second satellite, and
in the phase difference calculation, the phase difference is calculated using the first observation data transmitted from the first satellite and coordinates information indicating self-position of a satellite calculated using the second observation data acquired by the satellite.

6. The positioning method according to claim 5, wherein the second satellite transmits information on the base line vector calculated by the positioning apparatus to the ground stations.

7. A positioning apparatus comprising:
phase difference calculation means for performing phase difference calculation of a plurality of carrier waves observed in a first satellite and a second satellite using first observation data and second observation data, respectively, the first observation data being obtained through observation of phases of a plurality of carrier waves transmitted from a plurality of transmitting stations in the first satellite and the second observation data being obtained through observation of the phases of the plurality of the carrier waves in the second satellite; and
base line vector calculation means for calculating a base line vector indicating relative positions of the first satellite and the second satellite based on the phase difference calculated by the phase difference calculation means,
wherein the phase difference calculation means and the base line vector calculation means are installed in either one of the second satellite or the positioning apparatus located on the ground.

8. A satellite system comprising:
a first satellite;
a second satellite; and
at least four transmitting stations set up on the ground and configured to transmit carrier waves to the first satellite and the second satellite, wherein
first observation data is generated through observation of the phases of the plurality of the carrier waves in the first satellite,
second observation data is generated through observation of the phases of the plurality of the carrier waves in the second satellite,
phase difference calculation is performed to calculate a phase difference of the plurality of the carrier waves observed in the first satellite and the second satellite using the first observation data and the second observation data, respectively,
base line vector calculation is performed to calculate a base line vector indicating relative positions of the first satellite and the second satellite based on the phase difference calculated by performing the phase difference calculation, and
the phase difference calculation and the base line vector calculation are performed by either one of the second satellite or the receiving station located on the ground.
